(19) United States
(12) Patent Application Publication
(10) Pub. No.: US 2011/0225657 A1
(43) Pub. Date: Sep. 15, 2011

(54) METHOD AND APPARATUS FOR PREVENTING ILLEGAL SOFTWARE DOWNLOAD OF PORTABLE TERMINAL IN COMPUTER SYSTEM

(75) Inventor: Mi-Hee SEO, Bucheon-si (KR)

(73) Assignee: SAMSUNG ELECTRONICS CO. LTD., Suwon-si (KR)

(21) Appl. No.: 13/043,906

(22) Filed: Mar. 9, 2011

(30) Foreign Application Priority Data
Mar. 9, 2010 (KR) 10-2010-0020678

(51) Int. Cl. G06F 7/04

(52) U.S. Cl. 726/26

(57) ABSTRACT

A method and an apparatus for preventing an illegal SoftWare (SW) download of a portable terminal in a computer system are provided. The method includes receiving an input of an SW binary, acquiring an encryption result value by applying a predefined encryption algorithm to the SW binary, mapping and storing the SW binary and the encryption result value, and, when receiving a request for transmission of an SW binary for a Mobile Station (MS) from a computer, transmitting a corresponding SW binary and an encryption result value to the computer.

### PRIORITY

This application claims the benefit under 35 U.S.C. §119(a) to a Korean patent application filed in the Korean Intellectual Property Office on Mar. 9, 2010 and assigned Serial No. 10-2010-0020678, the entire disclosure of which is hereby incorporated by reference.

### BACKGROUND OF THE INVENTION

1. Field of the Invention

The present invention relates to a computer system. More particularly, the present invention relates to a method and an apparatus for preventing an illegal SoftWare (SW) download of a portable terminal in a computer system.

2. Description of the Related Art

With a sudden increase of the use of portable terminals, terminal manufacturers are endeavoring to develop more convenient and special functions in order to attract more users. As the functions of portable terminals are changing every day as above, each manufacturer is providing a download solution for downloading the latest version of SoftWare (SW) having a new function to the portable terminals.

Commonly, the download solution is divided into a normal mode and an emergency mode. The normal mode is a mode of, if a download program of a computer is executed and a portable terminal of a booted state is connected with the computer, acquiring the latest version of SW from an SW management server through version, and country (or district) information, and the like, of the connected portable terminal in the download program of the computer, storing the acquired SW in the user computer, and downloading the SW to the portable terminal. In contrast, the emergency mode is a mode used when, during a SW download in the normal mode, the download is abnormally ended by reason of disconnection between the computer and the portable terminal. The emergency mode performs the download without identifying the version and the country information of the connected portable terminal.

In a scheme of performing unconditional download without identifying information of portable terminals in an emergency mode as above, there is a problem that user's illegal SW download cannot be prevented, and this leads directly to a loss for a manufacturer. That is, in a case of using an illegal SW binary processed by a user instead of using a legal SW binary (or execution file) published by the manufacturer, it frequently happens that a corresponding portable terminal is not booted or is abnormally operated. In this case, because it is difficult that the manufacturer finds out a fact that a user downloads an illegal SW, there is a problem that the manufacturer should bear the expense of repairing the portable terminal.

Therefore, a need exists for a technique for preventing users from downloading an illegally published SW binary to a portable terminal.

### SUMMARY OF THE INVENTION

An aspect of the present invention is to address at least the above-mentioned problems and/or disadvantages and to provide at least the advantages described below. Accordingly, an aspect of the present invention is to provide a method and an apparatus for preventing an illegal SoftWare (SW) download of a portable terminal in a computer system.

Another aspect of the present invention is to provide a method and an apparatus for verifying SW to be downloaded using a hash algorithm in a computer system.

The above aspects are achieved by providing a method and an apparatus for preventing an illegal SW download of a portable terminal in a computer system.

According to an aspect of the present invention, a method for preventing an illegal SW download of a portable terminal in a server is provided. The method includes receiving an input of an SW binary, acquiring an encryption result value by applying a predefined encryption algorithm to the SW binary, mapping and storing the SW binary and the encryption result value, and, when receiving a request for transmission of an SW binary for a Mobile Station (MS) from a computer, transmitting a corresponding SW binary and an encryption result value to the computer.

According to another aspect of the present invention, a method for preventing an illegal SW download of a portable terminal in a computer is provided. The method includes receiving an SW binary for a previously connected MS and a 1st encryption result value, from an SW management server, when an SW binary download start event occurs, acquiring a 2nd encryption result value by applying a predefined encryption algorithm to an SW binary stored in a predefined storage position, comparing the 1st encryption result value with the 2nd encryption result value, and, according to the comparison result, performing or prohibiting the download of the SW binary stored in the predefined storage position.

According to a further aspect of the present invention, an apparatus for preventing an illegal SW download of a portable terminal in a server is provided. The apparatus includes a controller, a storage unit, and a communication module. The controller receives an input of an SW binary and, by applying a predefined encryption algorithm to the input SW binary, acquires an encryption result value. The storage unit maps and stores the SW binary and the encryption result value. When receiving a request for transmission of an SW binary for an MS from a computer, the communication module transmits an SW binary stored in the storage unit and an encryption result value to the computer under the control of the controller.

According to yet another aspect of the present invention, an apparatus for preventing an illegal SW download of a portable terminal in a computer is provided. The apparatus includes a communication module, a storage unit, and a controller. The communication module receives an SW binary for a previously connected MS and a 1st encryption result value, from an SW management server. The storage unit stores an SW binary in a predefined storage position. When an SW binary download start event occurs, the controller acquires a 2nd encryption result value by applying a predefined encryption algorithm to the SW binary stored in the predefined storage position, compares the 1st encryption result value with the 2nd encryption result value and, according to the comparison result, performs or prohibits the download of the SW binary stored in the predefined storage position.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will become more apparent from the following description taken in conjunction with the accompanying drawings, in which:

FIG. 1 is a diagram illustrating a construction of a system according to an exemplary embodiment of the present invention;

FIG. 2 is a block diagram illustrating a construction of a SoftWare (SW) management server and a user Personal Computer (PC) according to an exemplary embodiment of the present invention;

FIG. 3 is a flowchart illustrating an operation procedure of an SW management server according to an exemplary embodiment of the present invention; and

FIG. 4 is a flowchart illustrating an operation procedure of a user PC according to an exemplary embodiment of the present invention.

Throughout the drawings, like reference numerals will be understood to refer to like parts, components, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention provide a method and an apparatus for preventing an illegal SoftWare (SW) download by verifying SW to be downloaded using a hash algorithm in a computer system. In the following description, the hash algorithm is exemplified, but the exemplary embodiments of the present invention are identically applicable even to a different encryption algorithm.

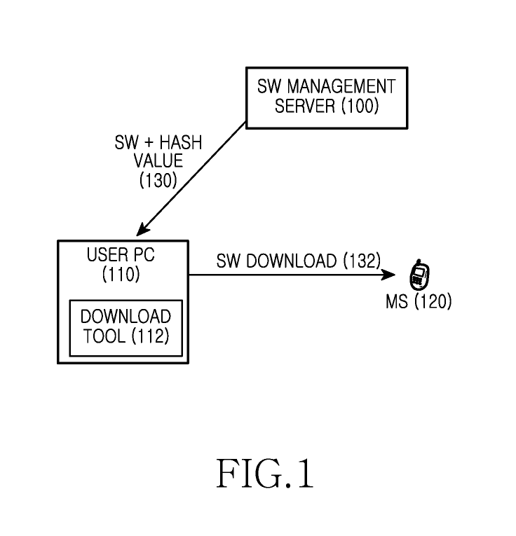

FIGS. 1 through 4, discussed below, and the various exemplary embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the invention. Terms first, second, and the like are used to differentiate between objects having the same terminology and are in no way intended to represent a chronological order, unless where explicitly state otherwise. A set is defined as a non-empty set including at least one element.

FIG. 1 is a diagram illustrating a construction of a system according to an exemplary embodiment of the present invention.

Referring to FIG. 1, an SW management server 100 manages and stores an SW binary provided by a manufacturer. The SW management server 100 generates a hash value for each SW binary according to a predefined hash algorithm and stores the hash value. If a user Personal Computer (PC) 110 receives a request for SW binary transmission for a Mobile Station (MS) 120, in step 130, the SW management server 100 transmits a corresponding SW binary and a hash value corresponding to the SW binary to the user PC 110.

If a download tool 112 for downloading an SW binary to an MS is executed, the user PC 110 acquires identification information of the MS 120 connected through a Universal Serial Bus (USB) and, based on the identification information, the user PC 110 acquires a corresponding SW binary from the SW management server 100. In step 130, the user PC 110 receives an SW binary for the MS 120 and a hash value corresponding to the SW binary from the SW management server 100, encrypts the hash value, and then stores the encrypted hash value.

Thereafter, when an SW binary download start event occurs through the download tool 112, the user PC 110 acquires a hash value by applying a hash algorithm to an SW binary of a predefined storage position, i.e., an SW binary to be downloaded to the MS 120, decodes the encrypted and stored hash value, and then determines if the two hash values (i.e., the acquired hash value and the encrypted and stored hash value) are the same.

If the user PC 110 determines that the two hash values are the same, the user PC 110 regards the SW binary of the predefined storage position as a legally published SW binary and thus, in step 132, performs an operation for downloading the SW binary of the predefined storage position to the MS 120. In contrast, if the user PC 110 determines that the two hash values are not the same, the user PC 110 regards the SW binary of the predefined storage position as an illegal SW binary and prohibits the SW binary of the predefined storage position from being downloaded to the MS 120. At this time, the user PC 110 may either display a message indicating that the SW binary of the predefined storage position is damaged on a screen, or transmit the message to the MS 120.

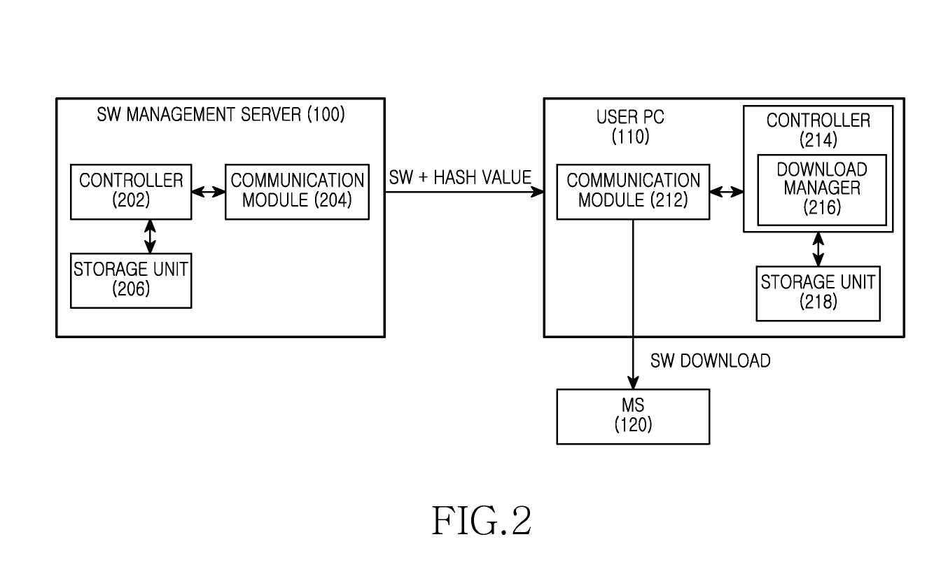

FIG. 2 is a block diagram illustrating a construction of an SW management server and a user PC according to an exemplary embodiment of the present invention.

Referring to FIG. 2, an SW management server 100 includes a controller 202, a communication module 204, and a storage unit 206. The user PC 110 includes a communication module 212, a controller 214, and a storage unit 218. More particularly, the controller 214 of the user PC 110 includes a download manager 216.

The controller 202 of the SW management server 100 performs an operation for controlling and processing the general operation of the SW management server 100. The controller 202 controls a function for, if a new SW binary is input by a manager, acquiring a hash value by applying a predefined hash algorithm to the input SW binary, mapping the acquired hash value to the input SW binary, and storing the mapping result in the storage unit 206. In addition, the controller 202 controls and processes a function for, when receiving a request for SW binary transmission for a specific MS from the user PC 110 through the communication module 204, searching for an SW binary corresponding to the specific MS in the storage unit 206 and transmitting the searched SW binary and a hash value corresponding to the SW binary to the user PC 110. Here, the controller 202 may receive identifier, model name, version, and country information, and the like, of the specific MS from the user PC 110 to search for the SW binary corresponding to the specific MS.

The communication module 204 processes a signal transmitted/received between the SW management server 100 and the user PC 110. More particularly, the communication module 204 receives a signal, which includes identifier, model name, version, and country information, and the like, of a specific MS and requests SW binary transmission, from the user PC 110. Under the control of the controller 202, the communication module 204 transmits an SW binary and a hash value corresponding to the SW binary to the user PC 110.

The storage unit 206 stores various kinds of programs and data necessary for an operation of the SW management server 100, and stores an SW binary and a hash value corresponding to the SW binary. In addition, the storage unit 206 may store a hash algorithm for acquiring a hash value from the SW binary.

Next, under the control of the controller 214, the communication module 212 of the user PC 110 processes a signal transmitted/received between the SW management server 100 and an MS 120. More particularly, under the control of the controller 214, the communication module 212 transmits a signal, which includes identifier, model name, version, and country information, and the like, of the MS 120 and requests SW binary transmission, to the SW management server 100, receives an SW binary and a hash value corresponding to the SW binary from the SW management server 100, and provides the received SW binary and hash value to the controller 214.

The controller 214 controls and processes the general operation of the user PC 110. The controller 214 includes the download manager 216 and controls and processes a function for, if a download tool 112 is executed, acquiring information of an MS connected through an USB (i.e., identifier, model name, version, and country information, and the like, of the MS) and acquiring an SW binary corresponding to the connected MS from the SW management server 100. If an SW binary and a hash value are received from the SW management server 100 through the communication module 212, the controller 214 stores the SW binary in a predefined storage position, and encrypts and stores the hash value. Here, the predefined storage position represents a position for storing an SW binary to be downloaded through the download tool 112.

Thereafter, if a download start event occurs through the download tool 112, the controller 214 acquires a hash value by applying a predefined hash algorithm to the SW binary stored in the predefined storage position, again decodes the encrypted and stored hash value, and compares the two hash values with each other. This is for determining if the SW binary stored in the predefined storage position has been changed. Here, the predefined hash algorithm should be identical with the hash algorithm of the SW management server 100.

If the controller 214 determines that the two hash values are the same, the controller 214 performs a function for downloading the SW binary of the predefined storage position to the MS 120 and, if the two hash values are not the same, the controller 214 prohibits the SW binary of the predefined storage position from being downloaded to the MS 120. At this time, the controller 214 may either display a message indicating that the SW binary is damaged through a screen of the user PC 110, or may transmit the message to the MS 120.

The storage unit 218 stores various kinds of programs and data for an operation of the user PC 110. More particularly, the storage unit 218 stores an SW binary and a hash value received from the SW management server 100 under the control of the controller 214. Undoubtedly, the hash value is encrypted and stored so that a user cannot be aware of the hash value.

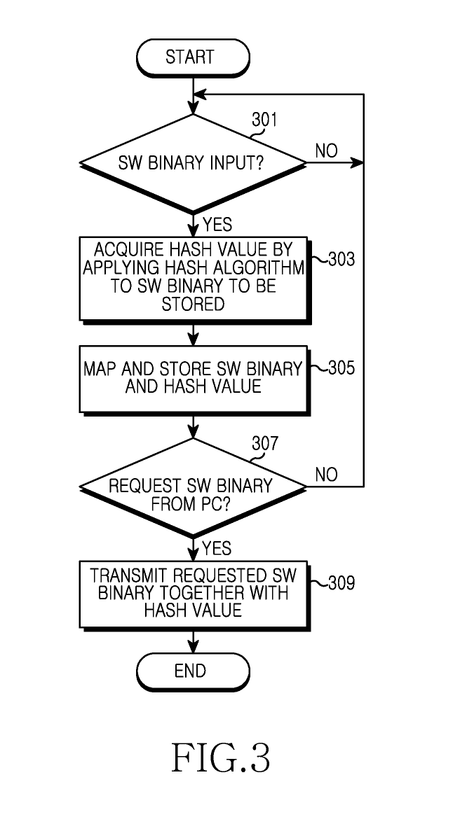

FIG. 3 is a flowchart illustrating an operation procedure of an SW management server according to an exemplary embodiment of the present invention.

Referring to FIG. 3, in step 301, an SW management server determines if a new SW binary is input by a manager. If it is determined in step 301 that the new SW binary is input by the manager, the SW management server acquires a hash value by applying a predefined hash algorithm to the new SW binary input in step 303. In step 305, the SW management server maps and stores the SW binary and hash value. At this time, the SW management server may store the SW binary together with model name, version, and country information of a corresponding MS.

Thereafter, in step 307, the SW management server determines if it receives a request for SW binary transmission for a specific MS from a user PC. At this time, a signal for requesting the SW binary transmission for the specific MS may include identifier, model name, version, and country information on the specific MS.

If it is determined in step 307 that a request for SW binary transmission for the specific MS from the user PC has not been received, the SW management server returns to step 301 and again performs the subsequent steps. In contrast, if it is determined in step 307 that a request for SW binary transmission for the specific MS from the user PC has been received, the SW management server proceeds to step 309 and searches for an SW binary corresponding to the specific MS, and transmits the searched SW binary and a corresponding hash value to the user PC. At this time, the SW binary corresponding to the specific MS may be searched using at least one of identifier, model name, version, and country information of the specific MS.

Thereafter, the SW management server terminates the procedure.

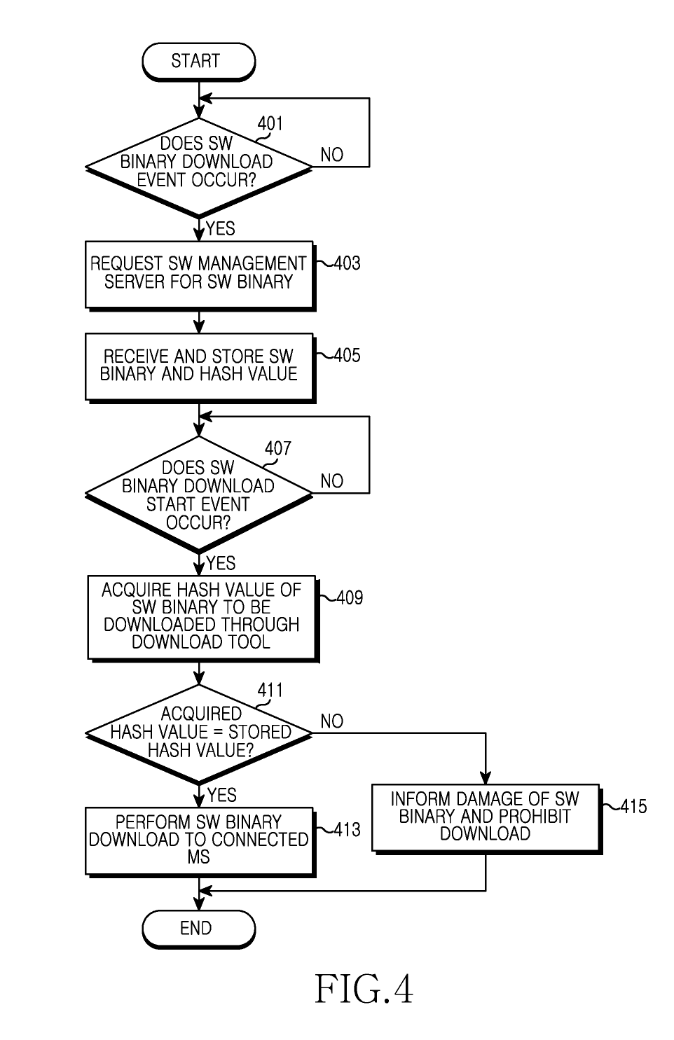

FIG. 4 is a flowchart illustrating an operation procedure of a user PC according to an exemplary embodiment of the present invention.

Referring to FIG. 4, in step 401, a user PC determines if an SW binary download event occurs. For example, the user PC determines if the SW binary download event occurs by connecting an MS to the user PC through a USB or by executing a download tool 112 in a state where the MS is connected.

If it is determined in step 401 that the SW binary download event occurs, the user PC proceeds to step 403 and requests the SW management server to transmit an SW binary for the connected MS. At this time, the user PC acquires identifier, model name, version, and country information, and the like, from the connected MS and transmits the acquired information to the SW management server.

In step 405, the user PC receives an SW binary and a hash value corresponding to the SW binary from the SW management server and stores the SW binary and hash value. The user PC then stores the SW binary in a predefined position, and encrypts and stores the hash value. The predefined storage position denotes a position for storing an SW binary to be downloaded through a download tool 112. Here, the user PC may display a message representing the completion of a download preparation on a screen after storing the SW binary and the encrypted hash value.

In step 407, the user PC determines if an SW binary download start event occurs. For example, the user PC determines the input or non-input of information representing that a user agrees to SW binary download through the download tool 112.

If it is determined in step 407 that the SW binary download start event occurs, the user PC acquires a hash value of an SW binary to be downloaded through the download tool 112 in step 409. That is, the user PC acquires a hash value by applying a predefined hash algorithm to the SW binary, which is stored in the predefined storage position, i.e., in the storage position for storing an SW binary to be downloaded through the download tool. Here, the predefined hash algorithm should be identical with a hash algorithm of the SW management server.

In step 411, the user PC decodes the encrypted and stored hash value of step 405 and then, compares if the decoded hash value is the same as the hash value of step 409 acquired from the SW binary to be downloaded. This is for determining if the SW binary stored in the predefined storage position has been changed.

If it is determined in step 411 that the decoded hash value is the same as the hash value acquired from the SW binary to be downloaded, the user PC proceeds to step 413 and performs an operation of downloading the SW binary of the predefined storage position to the connected MS, and then terminates the procedure.

In contrast, if it is determined in step 411 that the decoded hash value is not the same as the hash value acquired from the SW binary to be downloaded, the user PC proceeds to step 415 and indicates that the SW binary of the predefined storage position is damaged and prohibits the SW binary from being downloaded to the MS. The user PC may then either display a message indicating that the SW binary is damaged through a screen of the user PC, or may transmit the message to the connected MS.

Thereafter, the user PC terminates the procedure.

As described above, exemplary embodiments of the present invention may verify a SW to be downloaded using a hash algorithm in a computer system and then download only the verified SW, thereby preventing the SW from being illegally downloaded to a portable terminal and reduce a manufacturer's expense of exchange or repair resulting from user's illegal SW download.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for preventing an illegal SoftWare (SW) download of a portable terminal in a server, the method comprising:
receiving an input of an SW binary;
by applying a predefined encryption algorithm to the SW binary, acquiring an encryption result value;
mapping and storing the SW binary and the encryption result value; and
when receiving a request for transmission of an SW binary for a Mobile Station (MS) from a computer, transmitting a corresponding SW binary and an encryption result value to the computer.

2. The method of claim 1, further comprising:
receiving at least one piece of information among identifier, model name, version, and country information on the MS from the computer; and
searching for an SW binary for the MS using the at least one piece of information.

3. The method of claim 1, wherein the SW management server and the computer use the same encryption algorithm.

4. The method of claim 1, wherein the encryption algorithm is a hash algorithm.

5. A method for preventing an illegal SoftWare (SW) download of a portable terminal in a computer, the method comprising:
receiving an SW binary for a previously connected Mobile Station (MS) and a 1st encryption result value from an SW management server;
when an SW binary download start event occurs, acquiring a 2nd encryption result value by applying a predefined encryption algorithm to an SW binary stored in a predefined storage position;
comparing the 1st encryption result value with the 2nd encryption result value; and
according to the comparison result, performing or prohibiting the download of the SW binary stored in the predefined storage position.

6. The method of claim 5, wherein the performing or the prohibiting of the downloading of the SW binary stored in the predefined storage position according to the comparison result comprises:
if the 1st encryption result value is the same as the 2nd encryption result value, downloading the SW binary stored in the predefined storage position to the MS; and
if the 1st encryption result value is not the same as the 2nd encryption result value, prohibiting the SW binary stored in the predefined storage position from being downloaded to the MS.

7. The method of claim 5, further comprising requesting the SW management server to transmit an SW binary corresponding to the previously connected MS,
wherein a signal for requesting the SW binary transmission comprises at least one piece of information among identifier, model name, version, and country information on the MS.

8. The method of claim 5, further comprising:
after receiving the SW binary and the 1st encryption result value, storing the SW binary in the predefined storage position;
encrypting and storing the 1st encryption result value; and
before comparing the 1st encryption result value with the 2nd encryption result value, decoding the encrypted 1st encryption result value.

9. The method of claim 5, wherein the SW management server and the computer use the same encryption algorithm.

10. The method of claim 5, wherein the encryption algorithm is a hash algorithm.

11. An apparatus for preventing an illegal SoftWare (SW) download of a portable terminal in a server, the apparatus comprising:
a controller for receiving an input of an SW binary and for, by applying a predefined encryption algorithm to the input SW binary, acquiring an encryption result value;
a storage unit for mapping and storing the SW binary and the encryption result value; and
a communication module for, when receiving a request for transmission of an SW binary for a Mobile Station (MS) from a computer, transmitting an SW binary stored in the storage unit and an encryption result value to the computer under the control of the controller.

12. The apparatus of claim 11, wherein the communication module receives at least one piece of information among identifier, model name, version, and country information on the MS from the computer, and
wherein the controller searches for an SW binary for the MS in the storage unit, using the at least one piece of information.

13. The apparatus of claim 11, wherein the SW management server and the computer use the same encryption algorithm.

14. The apparatus of claim 11, wherein the encryption algorithm is a hash algorithm.

15. An apparatus for preventing an illegal SoftWare (SW) download of a portable terminal in a computer, the apparatus comprising:
a communication module for receiving an SW binary for a previously connected Mobile Station (MS) and a 1st encryption result value from an SW management server;
a storage unit for storing an SW binary in a predefined storage position; and
a controller for, when an SW binary download start event occurs, acquiring a 2nd encryption result value by applying a predefined encryption algorithm to the SW binary stored in the predefined storage position, comparing the 1st encryption result value with the 2nd encryption result value and, according to the comparison result, performing or prohibiting the download of the SW binary stored in the predefined storage position.

16. The apparatus of claim 15, wherein, if the 1st encryption result value is the same as the 2nd encryption result value, the controller controls to download the SW binary stored in the predefined storage position to the MS and, if the 1st encryption result value is not the same as the 2nd encryption result value, prohibits the SW binary stored in the predefined storage position from being downloaded to the MS.

17. The apparatus of claim 15, wherein the communication module requests the SW management server to transmit an SW binary corresponding to the previously connected MS, and
wherein a signal for requesting the SW binary transmission comprises at least one piece of information among identifier, model name, version, and country information on the MS.

18. The apparatus of claim 15, wherein the controller encrypts the 1st encryption result value and, before comparing the 1st encryption result value with the 2nd encryption result value, decodes the encrypted 1st encryption result value.

19. The apparatus of claim 15, wherein the SW management server and the computer use the same encryption algorithm.

20. The apparatus of claim 15, wherein the encryption algorithm is a hash algorithm.
